(19) United States
(12) Patent Application Publication
(10) Pub. No.: US 2007/0227867 A1
(43) Pub. Date: Oct. 4, 2007

(54) Integrating structure of switch plates

(76) Inventor: Hsiu-Ling Yang, Tauy uan City (TW)

Correspondence Address: Yang, Hsiu-Ling, 20525 Via Talavera,, Yorba Linda, CA, 92887, US

(21) Appl. No.: 11/396,321

(22) Filed: Apr. 3, 2006

(51) Int. Cl. H01H 9/00

(52) U.S. Cl. 200/310

(57) ABSTRACT

The present invention provides an improved integrating structure of switch plate comprising a frame, a switch plate and a control circuit. The frame is surrounded on the circumstantial edges of a switch button located on a wall, wherein an opening is provided correspondingly to a connecting wire box at a centre of the frame. The connecting wire box is utilized to connect electrical wires and control wires via the opening to connect to the switch button such that a switch device is formed. The switch plate covers a surface area of the frame, and a central portion of the switch plate is designed to match the switch button. The control circuit is located in between the frame and the switch plate, wherein a light sensor is utilized to sense external light and initiate a plurality of light units located on circumstantial edges of the opening of the frame accordingly to the brightness of an environment so that the switch plate can illuminate light automatically in a dark or lack of lighting condition.

### BACKGROUND OF THE INVENTION

1. Field of Invention

The present invention relates to an improved structure of switch plates. More particularly, the present invention relates to an integrated structure of switch plates that can assist lighting and provide various outlooks for the switches.

2. Description of the Related Art

FIG. 1 shows a conventional switch device and a conventional structure of a switch plate. The switch device comprises at least one switch button 41 located within a switch support 42 on a pre-set location. The switch support 42 is positioned firmly with screws onto a connecting wire box locating on a wall. An opening 431 is provided on a centre of the switch plate 43 assembled to the switch support 42 such that the switch button 41 can be integrated to the switch plate 43. The switch button 41 is exposed through the opening 431 but its circumstantial edges are covered by the switch plate 43 as shown in FIG. 1. An illuminating source 422 is provided on a top portion of the switch button 41 in order to reveal the position of the switch device in a dark or insufficient lighting environment. The illuminating source 411 illuminates soft lighting beam when the switch button 41 is cut off from the electrical power so that a user can locate the position of the switch button in the dark or insufficient lighting room. The illuminating source 411 also can decorate the outlook of the switch device.

However, the conventional switch device and the conventional structure of the switch plate comprises several disadvantages as the followings:
1. The lighting of the conventional illuminating source 411 is very weak, the user can barely identify the position of the switch button 41 in a dark room. The illuminating source 411 of the switch button 41 is not powerful enough to lighten up the position of the switch device and its circumstantial edges in such that the user normally has to use hand(s) by touching through the wall to locate the position of the switch device and the switch button. As a result, the circumstantial edges of the wall around the switch plate 43 are filthy from the touching. It is not only inconvenience for the user to find the position of the switch button in a dark environment, the polluted edges around the switch plate 43 also affect its outlook.
2. The prior art, switch button, is designed to focus on a function of switching on/off the electrical power. Since the prior art switch button does not comprises other functions than switching the power, its utilization is limited. The competitiveness of the product is very low.
3. The conventional switch button 41 is normally designed with a purpose of connecting to the connecting wire box located in the wall, the switch plate is therefore designed into a rectangular shaped or square shaped structure. The outlook structure of the conventional switch plate is boring without much variation. Therefore, the competitiveness of the switch plate cannot increased easily.

Thus, it is an object of the present invention to provide an improved integrating structure of switch plate to overcome those disadvantages of the conventional switch plate.

### SUMMARY OF THE INVENTION

It is an object of the present invention to provide an improved integrating structure of switch plate comprising a frame, a switch plate and a control circuit. The frame is surrounded on the circumstantial edges of a switch button located on a wall, wherein an opening is provided correspondingly to a connecting wire box at a centre of the frame. The connecting wire box is utilized to connect electrical wires and control wires via the opening to connect to the switch button such that a switch device is formed. The switch plate covers a surface area of the frame, and a central portion of the switch plate is designed to match the switch button. The control circuit is located in between the frame and the switch plate, wherein a light sensor is utilized to sense external light and initiate a plurality of light units located on circumstantial edges of the opening of the frame accordingly to the brightness of an environment so that the switch plate can illuminate light automatically in a dark or lack of lighting condition.

It is another object of the present invention to provide an improved integrating structure of switch plate comprising lighting function in a dark or lack of lighting environment.

It is another object of the present invention to provide an improved integrating structure of the switch plate with various designed of shapes that can provide different outlook and improve the competitiveness of the product.

Both the forgoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the invention. In the drawings,

FIG. 1 shows a conventional structure of switch plates;

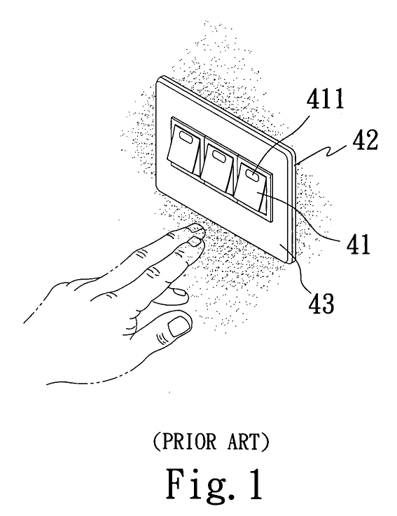

FIG. 2 shows a 3-D assembly view of an improved integrating structure of switch plates in accordance with a first preferred example of the present invention;

FIG. 3 illustrates a 3-D view of an integrated improved structure of switch plates in accordance with the first preferred example of the present invention;

FIG. 4 is a cross-sectional view of the improved integrating structure of switch plates in accordance with the preferred example of the present invention;

FIG. 5 is a 3-D view of an integrated structure of the switch plates in accordance with the first preferred example of the present invention;

FIG. 6 is a 3-D assembly view of an improved integrating structure of switch plate in accordance with a second preferred example of the present invention;

FIG. 7 is a cross-sectional view of the improved integrating structure of switch plate of the second preferred example;

FIG. 8 is a 3-D view of an integrated structure of switch plates in accordance with a third preferred example of the present invention.

### DESCRIPTION OF THE PREFERRED EMBODIMENTS

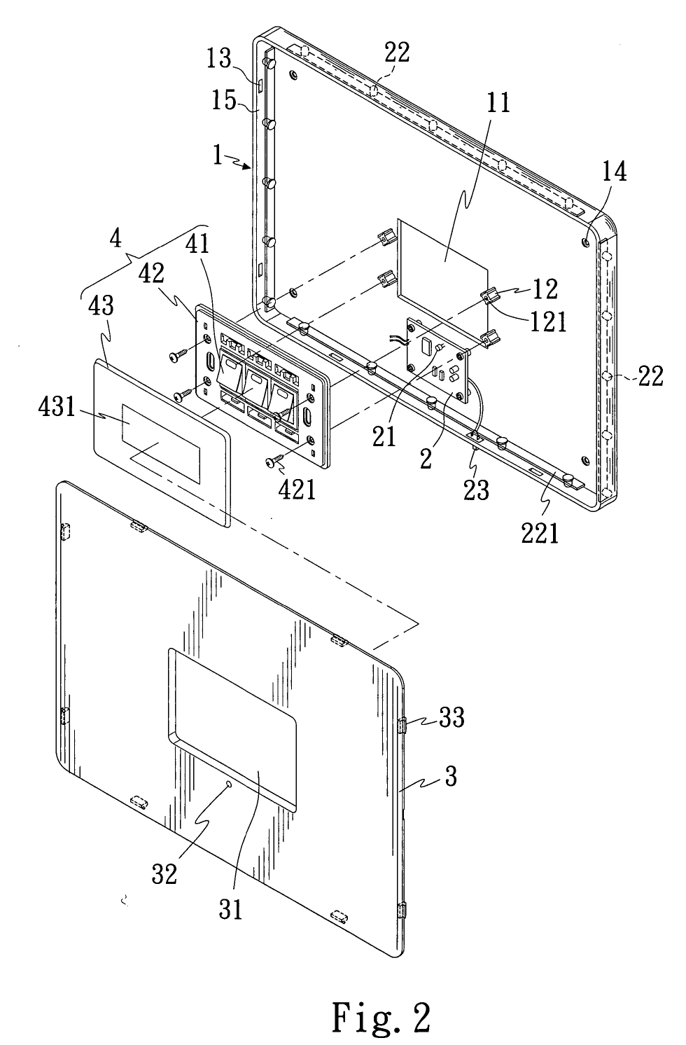

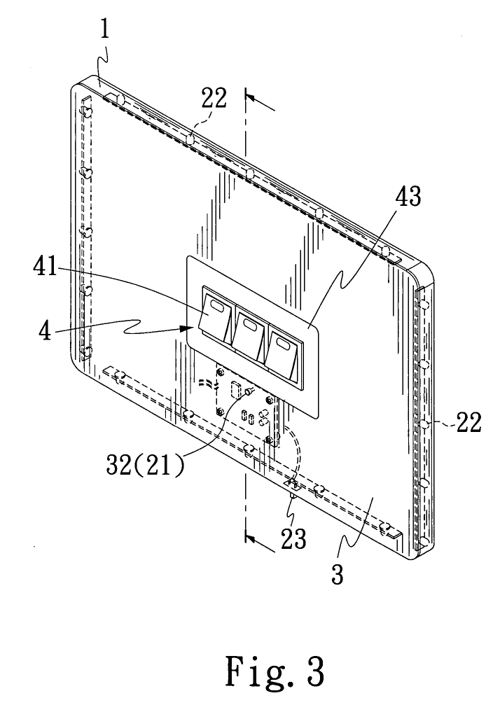

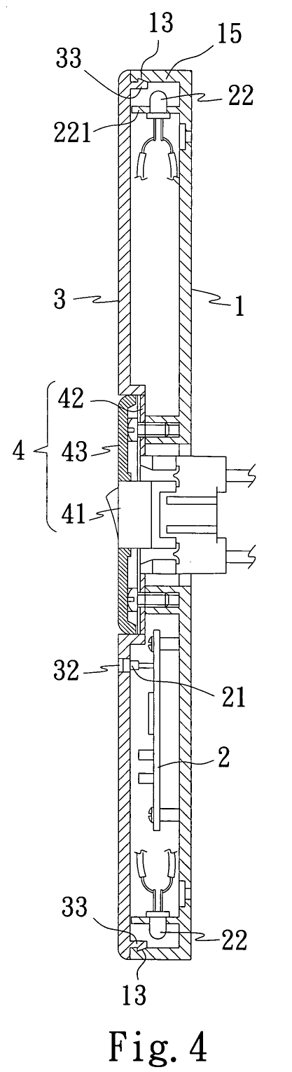

FIG. 2 shows a 3-D assembly view of an improved integrating structure of switch plates in accordance with a first preferred example of the present invention. FIG. 3 illustrates a 3-D view of an integrated improved structure of switch plates in accordance with the first preferred example of the present invention. FIG. 4 is a cross-sectional view of the improved structure of switch plates in accordance with the preferred example of the present invention.

The present invention provides an improved integrating structure of switch plates, wherein the improved structure of switch plates comprises a frame 1, a control circuit 2 and a switch plate 3. Pervious to light edges 15 are provided around the circumferential edges of the frame 1, wherein those edges can be transparent or opaque. A plurality of slots 13 are formed on the edges 15, wherein a plurality of fixed holes 14 are formed on an internal side of the edges 15 in order to locate fixed units, such as screws. The fixed units are utilized to penetrate through those fixed holes 14 so that the circumferences of the switch plates can be positioned on a surface of a wall. An opening 11 which is correspond to a connecting wire box inside the wall is provided at a centre of the frame 1, wherein the opening 11 is utilized for the electrical wires of the connecting wire box and control wires to extend externally. A plurality of fastening bases 12 providing screw holes 121 are located on the circumstantial edges of the opening 11 so that the screw holes 121 of the fastening bases 12 can be utilized to position a switch frame 42 of a switch device 4 through the opening 11 onto the frame 1.

At least one switch button 41 is provided on the switch frame 42, wherein the electrical wires and the control wires are connected electrically to the switch button 41. A switch plate 43 comprises an opening 431 located at a central portion thereon, wherein the switch plate 43 is integrated with a front portion of the switch frame 42 such that the switch button 41 is exposed outside the opening 431 of the switch plate 43. The control circuit 2 is located at a side part of the opening 11 of the frame 1, wherein a light sensor 21 is formed on the control circuit 2 to sense the external lighting. An output of the control circuit 2 is connected to a plurality of light units 22 such as, Light Emitting Diodes (LED). The plurality of LED 22 are positioned via an internal frame 221 into internal parts of the circumstantial edges of the frame 1.

An interchange switch 23 is positioned in the internal part of the button circumstantial edge of the frame 1 in order to switch off the electrical power of the control circuit 2. An opening 31 is formed on a central part of the external panel 3, wherein an air ventilating hole 32 which is formed on one side of the opening is correspond to the light sensor 21 of the control circuit 2. A plurality of hooks 33 are provided on the circumstantial edges of the switch plate 3 and are inserted into the slots of the frame 1 so that the switch plate 3 and the frame can be integrated firmly together. The switch plate 43 of the switch device 4 is exposed through the opening 31 of the switch plate 3.

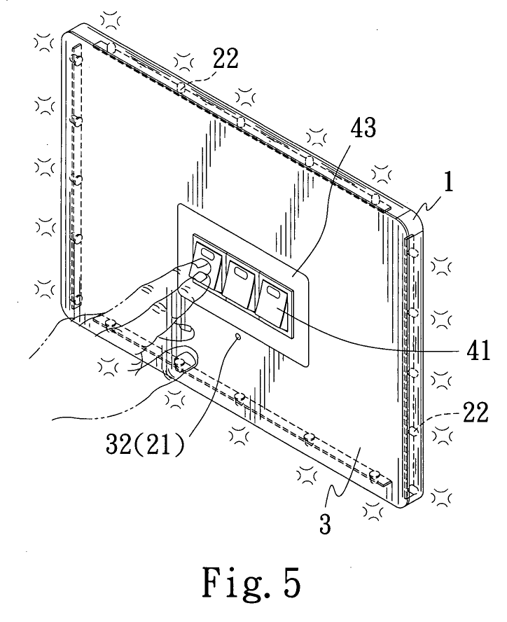

FIG. 5 is a 3-D view of an integrated structure of the switch plates in accordance with the first preferred example of the present invention. The light sensor 21 of the control circuit 2 senses external light via the air ventilating hole 32 of the external panel 3. When the switch plate 3 is located at an environment that is dark or shortage of light, the control circuit 2 can initiate the plurality of light units 22 to illuminate light via the light edges 15 of the frame 1 such that an illuminating ring is formed around the circumstantial edges of the frame 1 to allow the user identifying the location of the switch button 41 easily. Therefore, the user still can switch on/off the light easily in the dark condition. Since the switch button 41 of the switch device 4.

The switch plate 3 can be made from either non-illuminating materials or illuminating materials so that the whole structure of the switch plate is illuminated (it can be transparent or opaque). The light units 22 produce a soft light beam brightening out from the switch plate 3 in the dim room. Therefore, the light units 22 providing light and decorating the outlook of the switch plate 3 are few of it various utilizations. In an event of lighting is not required, the interchange switch 23 will cut off the electrical power of the control circuit so that the light units 22 will be switched off.

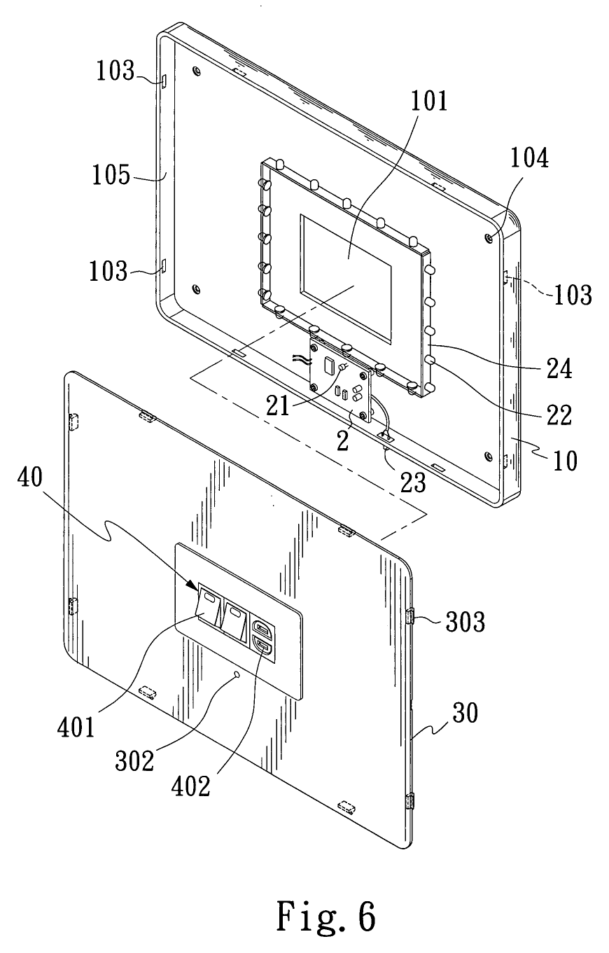

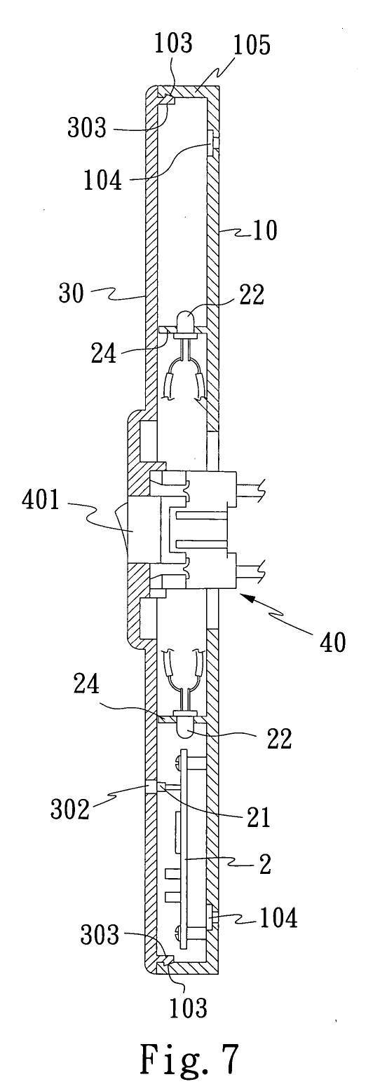

FIG. 6 is a 3-D assembly view of an improved integrating structure of switch plate in accordance with a second preferred example of the present invention. FIG. 7 is a cross-sectional view of the improved structure of switch plate of the present invention. The improved structure of switch plate of the second preferred example comprises a frame 10, a control circuit 2 and a switch plate 30. The frame 10 provides pervious to light edges 105 around the circumferential edges thereof, and a plurality of slots 103 are formed on the edges 105. A plurality of fixed holes 104 are formed on internal sides of the edges 105 to locate fixed units, such as screws penetrating through fixed holes 104 to position the switch plate 3 onto the a wall. An opening 101 is formed at a centre of the frame 10 and is correspond to a connecting wire box located inside the wall, wherein the opening 101 is utilized to allow the electrical wires of the connecting wire box and control wires extending externally. The control circuit 2 is located at a side part of the opening 101 of the frame 10. A light sensor 21 is formed on the control circuit 2 to sense the external light. An output of the control circuit 2 is connected to a plurality of light units 22 such as, Light Emitting Diodes (LED). The plurality of light units/LED 22 are positioned via an internal frame 24 into internal parts of the circumstantial edges of the opening 101.

An switch 23 is positioned in an internal circumstantial edge of the frame 10 in order to switch off the electrical power of the control circuit 2. The switch plate 30 is integrated with a switch device 40, wherein the switch device 40 can provide various types of switch buttons 401 and plugs 402 at different locations according to the its design. The switch buttons 401 and the plugs 402 can be connected to electrical wires and the control circuit 2 via the opening 101. An air ventilating hole 302 which is formed on one side of the opening is correspond to the light sensor 21 of the control circuit 2. A plurality of hooks 303 are provided on the circumstantial edges of the switch plate 30 and can be inserted into the slots 103 of the frame 10 so that the switch plate 30 and the frame can be integrated firmly together. The switch device 40 is exposed through the opening 101 of the switch plate 30.

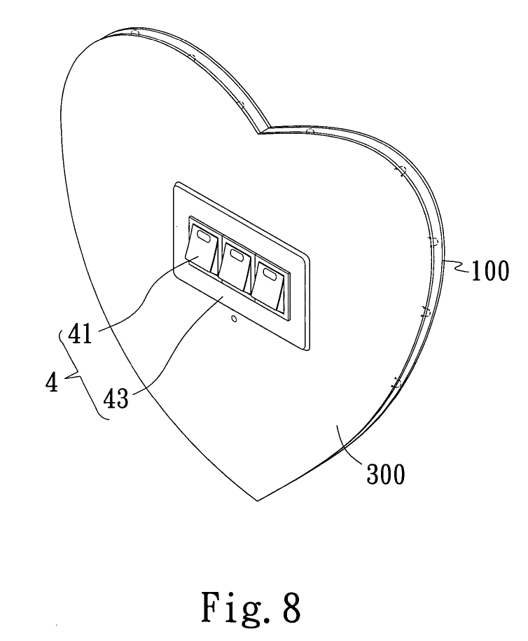

FIG. 8 is a 3-D view of an integrated structure of switch plates in accordance with a third preferred example of the present invention. The improved structure of the switch plate of the present invention can provide various designs of the switch plate, such as a frame 100 and a switch plate 300 shown in FIG. 8. The frame 100 and the switch plate 300 can be formed with different outlooks, such as a heart-shaped to increase the competitiveness of the product.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. An integrating structure of switch plate, comprising:
a frame, fastening onto a wall, wherein the frame surrounds a switch button of a switch device, and an opening is provided at a centre of the frame corresponding to a connecting wire box in order to allow electrical wires and control wires to extend through the opening and connect to the switch button;
a switch plate, covering a surface area of the frame, wherein a central portion of the switch plate is designed to match the switch device; and
a control circuit, locating in between the frame and the switch plate, wherein the control circuit drives a plurality of light units located on circumstantial edges of the opening of the frame according to the state of a light sensor for detecting external light in such that it can automatically provide a regional illumination in a dark or lack of lighting condition.

2. The integrating structure of switch plate of claim 1, wherein a plurality of hooks are provided on the circumstantial edges of the switch plate and are inserted into corresponding slots of the frame.

3. The integrating structure of switch plate of claim 1, wherein the switch plate and the switch device are connected.

4. The integrating structure of switch plate of claim 1, wherein a plurality of fastening bases having screw holes are located on the circumstantial edges of the opening of the frame so that the fastening bases can be utilized to locate a plurality of screws passing through the switch button, and an opening is provided at a central portion of the switch plate to expose the switch button.

5. The integrating structure of switch plate of claim 1, wherein the light units are located on internal circumstantial edges of the frame.

6. The integrating structure of switch plate of claim 1, wherein either the frame or the switch plate or the both are pervious to light.

7. The integrating structure of switch plate of claim 1, wherein the frame and the switch plate can be integrated to form various shapes of structures.

8. The integrating structure of switch plate of claim 1, wherein an switch is provided on the control circuit to switch off electrical power of the control circuit.
